(19) United States
(12) Patent Application Publication
(10) Pub. No.: US 2002/0161230 A1
(43) Pub. Date: Oct. 31, 2002

(54) Process for preparing boronic and borinic acids

(75) Inventors: Andreas Meudt, Weilbach (DE); Michael Erbes, Kelkheim (DE); Klaus Forstinger, Babenhausen (DE)

Correspondence Address: CLARIANT CORPORATION, INTELLECTUAL PROPERTY DEPARTMENT, 4000 MONROE ROAD, CHARLOTTE, NC, 28205, US

(73) Assignee: Clariant GmbH

(21) Appl. No.: 10/085,368

(22) Filed: Feb. 28, 2002

(30) Foreign Application Priority Data
Mar. 2, 2001 (DE) 10110051.5

(51) Int. Cl. C07F 5/02

(52) U.S. Cl. 546/13; 548/405; 562/7; 556/402; 556/404; 549/4

(57) ABSTRACT

A process for preparing boronic acids of the formula (I) and borinic acids of the formula (II),

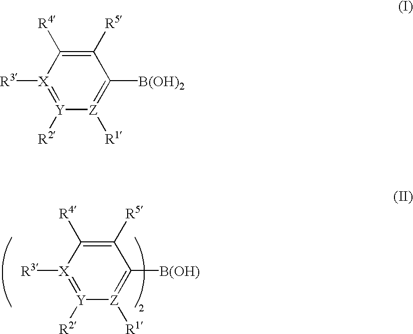

by reaction of chloroaromatics of the formula (III) with lithium metal and boron compounds BW′W′W′″, where W′, W′ and W′″ are each, independently of one another, C₁-C₆-alkoxy, fluorine, chlorine, bromine, iodine, N(C₁-C₆-alkyl)₂ or S(C₁-C₅-alkyl), in a solvent at temperatures in the range from −100 to 80° C.

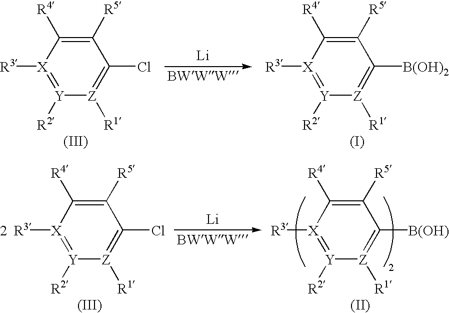

The invention relates to a process for preparing aromatic boronic and borinic acids.

Such boronic and borinic acids are versatile building blocks in organic synthesis (keyword: Suzuki couplings) and important intermediates in the synthesis of active compounds in the agrochemical and pharmaceutical industries, and such compounds are also of great economic interest for special applications in a wide variety of areas, for example as: cocatalysts for olefin polymerization.

Owing to the existing high economic interest in these compounds, numerous routes for preparing boronic acids and borinic acids, depending on their specific substitution pattern, have been described in the literature.

Most of the processes of the prior art comprise reacting aryl Grignard compounds with boron compounds in a ratio of about 1:1 in the case of boronic acids and about 2:1 in the case of borinic acids. In general, these reactions give good yields of boronic acids (usually 50-80%) and moderate yields (usually <65%) of borinic acids (generally applicable methods of preparing boronic acids: Washburn, Org. Synth. 1959, 39, 3; Povlock, J. Am. Chem. Soc. 1958, 80, 5409; Snyder, J. Am. Chem. Soc. 1948, 70, 234; preparation of mixtures of boronic and borinic acids: Hawthorne, J. Org. Chem. 1957, 22, 1001; preparation of borinic acids: Colette, Organomet. 11(2), 652-657 (1992)).

Bromoaromatics are used most successfully in the preparation of the Grignard compounds, since the Grignard compounds can be prepared most easily (the reaction starts well, high yields, little biphenyl formation). Unfortunately, these bromoaromatics are in most cases very much more expensive than the corresponding chloroaromatics (“Organomagnesium methods in organic synthesis”, Wakefield, Academic Press, p. 32/33).

lodoaromatics are significantly more expensive still, and they result in increased formation of biphenyls in the Grignard preparation, as a result of which poor overall yields and moderate purities of the target compounds are obtained.

For the abovementioned reasons, it is necessary to use chloroaromatics if an economical process for preparing boronic acids and borinic acids is to be achieved. Unfortunately, the preparation of Grignard compounds from chloroaromatics is not always possible, since many chloroaromatics are, as is known, able to be converted into Grignard compounds only with difficulty and in poor yields, if at all. This applies, for example, to 1-chloronaphthalene in the case of which specialized and expensive techniques such as the use of Rieke magnesium are necessary to achieve worthwhile conversions (“Organomagnesium methods in organic synthesis”, Wakefield, Academic Press).

From a process engineering point of view, the preparation of Grignard compounds from chloroaromatics is problematical because the reaction frequently does not start at all initially and then starts very suddenly and often in an uncontrolled manner. It is often found that the time until the reaction starts depends greatly on the quality of the solvents used (for example water content, content of free radical formers and metal ions, etc.). These are not optimum conditions for a controlled industrial process.

The reaction of the aryl Grignard compounds with boron compounds, usually boric esters or halides, is often associated with low yields in the case of the preparation of borinic acids, because complexes, for example of the formula Ar—B(OR)₃⁻are initially formed, which makes addition of a second aryl equivalent more difficult. As a result, the products are frequently mixtures of boronic and borinic acids (Hawthorne, J. Org. Chem. 1957, 22, 1001), so that only moderate overall yields can be obtained after the necessary purification.

However, the greatest problem and the biggest cost factor in the preparation of boronic and borinic acids via aryl Grignard compounds is the complicated apparatus required. Since aryl Grignard compounds are commercially available only in very few cases and then at extremely high prices, the Grignard compound has to be prepared in a first vessel which is usually held at reflux temperature, the reaction mixture has to be cooled in this vessel when complete conversion is achieved, the boron compound has to be placed in a second vessel and cooled to a very low temperature, the likewise cooled Grignard compound subsequently has to be metered in, the mixture thawed and hydrolyzed in a third vessel (vessels 1 and 2 have to remain dry) and the work-up has to be carried out in this third vessel or a further vessel. The simultaneous occupation of a plurality of vessels and the time-consuming heating and cooling phases necessary in the case of relatively large amounts results in only moderate space-time yields and high production costs (Houben-Weyl, “Bor-Verbindungen I”, Edition IV, p. 636).

There is therefore a need for a process in which chloroaromatics and boron compounds are used as starting compounds and in which all process steps are ideally carried out at one and the same temperature or at only slightly different temperatures so that a long heating and cooling phase can be avoided. Even more important would be the ability to carry out the preparation of the organometallic reagent in the same vessel in which the reaction with the boron compound is carried out.

However, since the preparation of the Grignard compound usually has to be carried out at the reflux temperature of the solvent used but the borate addition has to be carried out at temperatures of <0° C. for selectivity reasons, this does not appear to be possible via a Grignard route.

A further route which is frequently used for preparing boronic and borinic acids is the reaction of lithiated aromatics with boron compounds. The preparation of lithioaromatics can likewise be carried out in numerous ways. For example, reaction of bromoaromatics and iodoaromatics with butyllithium is a standard method of generating lithioaromatics. This atom replacement can be carried out at low temperatures at which the reactions with boron compounds can then also be carried out.

Unfortunately, however, this reaction cannot be carried out using chloroaromatics, since, with very few exceptions, these do not react with butyllithium. Due to this fact and the high price of butyllithium, a particularly economical process does not result despite the abovementioned advantages.

Further methods of preparing lithium compounds have been widely described, but up to now there has not been any overall process for preparing boronic and borinic acids which meets all of the above-described requirements.

It is therefore an object of the invention to develop a process for preparing compounds of the formula (I) which starts from commercially readily available and favorably priced chlorine compounds, makes it possible to obtain the borinic and boronic acids required in good yields at high purities and is at the same time simple in process engineering terms, efficient and inexpensive. The latter implies the ability to carry out all process steps with the exception of hydrolysis and work-up at essentially the same temperature and if possible in one and the same reaction vessel. Ideally, the process also makes it possible to prepare the target compounds directly by simple stirring together of chloroaromatic, metal and boron compound in a suitable solvent.

The present invention achieves all these objects and provides a process for preparing boronic acids of the formula (I) and borinic acids of the formula (II),

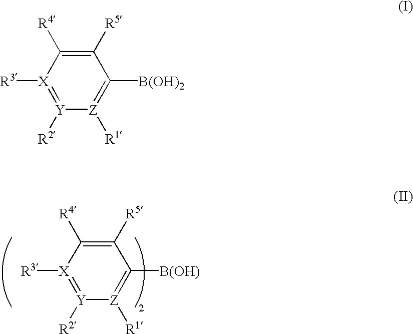

where

the substituents R^{1′} to R^{5′} are each, independently of one another, H, CH₃, straight-chain or branched C₁-C₈-alkyl, in particular C₁-C₄-alkyl, F, CₙH_{2n+1-f}F_{f} where n=1 to 8 carbon atoms and f=1 to 2n+1 fluorine atoms, CH(OC₁-C₅-alkyl)₂, C(C₁-C₅-alkyl)(OC1-C₅-alkyl), CH₂(OC₁-C₅-alkyl), CH(CH₃)(OC₁-C₅-alkyl), C₁-C₅-alkoxy, in particular C₁-C₄-alkoxy, N(C₁-C₅-alkyl)₂, phenyl, substituted phenyl, aryl, heteroaryl, S(C₁-C₅-alkyl), Pphenyl₂, Paryl₂ or P(C₁-C₅-alkyl)₂ and

the symbols X, Y and Z are each, independently of one another, carbon (phenylboronic or phenylborinic acids) or XR^{3′} YR^{2′} and/or ZR¹′ are/is nitrogen (pyridylboronic or pyridylborinic acids) or XR^{3′} and YR^{2′} are together oxygen (2-and 3-furanboronic or -furanborinic acids) or XR^{3′} and YR^{2′} are together N(C₁−C₅-alkyl) or N(SiMe₃) (pyrroleboronic or pyrroleborinic acids) or XR^{3′} and YR^{2′} are together sulfur (2-and 3-thiopheneboronic or - thiopheneborinic acids), by reaction of chloroaromatics of the formula (III) with lithium metal and reaction with boron compounds BW′W″W′″, where W′, W″ and W′″ are each, independently of one another, C₁-C₆-alkoxy, fluorine, chlorine, bromine, iodine, N(C₁-C₆-alkyl)₂ or S(C₁-C₅-alkyl),

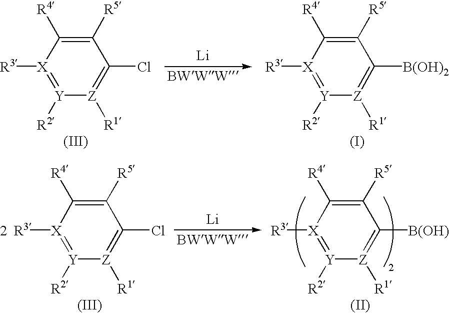

in a solvent at temperatures in the range from −100 to 80° C. Chloroaromatics which can be used according to the invention are, for example, p-chlorobenzotrifluoride, 2-chloropyridine, 2-chlorothiophene, 3-chlorothiophene, 2-chloronaphthalene, 1-chloronaphthalene, p -chloroanisole, chloropentafluorobenzene and p-fluorochlorobenzene, to name only a few.

Furthermore, anhydrides of boronic acids or borinic acids or esters with monohydric or polyhydric, straight-chain or branched alcohols can also be obtained according to the invention by varying the work-up conditions or drying conditions or by a subsequent reaction to form the derivatives.

The conversion according to the invention of chloroaromatics into boronic and borinic acids can be carried out by different process engineering routes depending on the substitution pattern of the target compounds and the circumstances of the respective production operations. One possible method is to stir the chloroaromatic with lithium in a suitable solvent at the reaction temperature until the chloroaromatic is essentially completely converted into the lithioaromatic, and then to add the boron compound BW′W″W′″ at the same or essentially the same temperature (difference <50 K) and react it with the lithioaromatic, with all steps being able to be carried out in one reaction vessel (single-vessel process). Alternatively, the chloroaromatic can be reacted simultaneously with lithium and the boron compound BW′W″W′″ while stirring in a suitable solvent and at a suitable temperature, preferably at a temperature in the range from −85 to +25° C., thus directly forming the complexes of the borinic and boronic acids which, after hydrolysis, give the free borinic and boronic acids. It is also possible for the lithioaromatic to be generated first and then, in a converse manner to that described above, be added to a boron compound. Particularly preferred embodiments are the first-mentioned single-vessel processes.

In a further embodiment of the process of the invention, the preparation of the lithoaromatic and the reaction with the boron compound can be carried out in two separate reaction vessels. Here, the reaction of the chloroaromatic with the lithium metal to form a lithoaromatic and the subsequent reaction of the lithoaromatic with the boron compound BW′W″W′″ can be carried out at the same temperature or an only slightly different temperature (<50 K difference).

Suitable solvents for the conversion according to the invention of chloroaromatics into borinic and boronic acids are aliphatic and aromatic ethers and hydrocarbons and amines which have no hydrogen on the nitrogen, preferably triethylamine, diethyl ether, tetrahydrofuran (THF), di-n-butyl ether, tert.-butyl methyl ether, xylene, toluene, toluene/tetrahydrofuran mixtures, anisole or diisopropyl ether, or solvent mixtures comprising one of the above solvents, particularly preferably triethylamine, THF or diisopropyl ether.

The conversion according to the invention of chloroaromatics into borinic and boronic acids is advantageously carried out a temperatures of from −100° C. to +80° C., preferably from −80° C. to +20° C., particularly preferably from −65° C. to −10° C.

In the present process, the lithium can be used as dispersion, powder, turnings, sand, granules, lumps, bars or in another form, with the size of the lithium particles not being relevant to quantity but merely influencing the reaction times. For this reason, preference is given to relatively small particle sizes, for example granules, powder or dispersions.

The reaction times are usually in the range from 0.5 to 15 hours, preferably in the range from 3 to 10 hours.

Preference is given to using from 2.0 to 3.0 equivalents, particularly preferably from 2.0 to 2.4 equivalents, of lithium per mol of chloro compound of the formula (III).

As boron compounds, use is made of the compounds of the formula BW′W″W′″, where W′, W″ and W′″ are each, independently of one another, C₁-C₆-alkoxy, fluorine, chlorine, bromine, iodine, N(C₁-C₆-alkyl)₂ or S(C₁-C₅-alkyl); preference is given to trialkoxyboranes, BF₃*OR₂(where R=CH₃, C₂H₅, C₃H₇, C₄H₉), BF₃*THF, BCI₃ or BBr₃, particularly preferably trialkoxyboranes, and also compounds Cl₂B(OR) and BrB(NMe₂)₂, where R is as defined above.

In general, the lithium metal together with the appropriate solvent are placed in a reactor and the chloroaromatic of the formula (III), if desired dissolved in the same solvent or another solvent, is, in one of the preferred embodiments, introduced into the mixture simultaneously with the boron compound. In a further preferred embodiment, only the chloroaromatic, if desired dissolved in a solvent, is initially added to the lithium metal, the mixture is stirred until virtually complete conversion and the boron compound is only then introduced.

To work up the reaction solution, the solution is hydrolyzed either by adding water or aqueous mineral acids or by introducing the reaction mixture into water or aqueous mineral acids. In the further work-up, the boronic and borinic acids are, for example, isolated by extraction and evaporation of the organic phases; as an alternative, the organic solvents can be distilled off from the hydrolysis mixture and the precipitated product can then be isolated by filtration. Depending on the substitution pattern and the precise conditions, the free boronic acids or borinic acids may be obtained in this way. The anhydrides of these compounds are obtained by methods known to those skilled in the art, for example by drying under reduced pressure at elevated temperature. The esters of the boronic and borinic acids can likewise be obtained by customary methods, for example by reacting the crude products from the reactions according to the invention with the corresponding alcohols with chemical or physical removal of water.

To prepare boronic acids of the formula (I), use is generally made of from 0.96 to 1.30 equivalents, preferably from 0.98 to 1.15 equivalents, of the chloro compound of the formula (III) per mol of boron compound BW′W″W′″. To prepare borinic acids of the formula (II), it is generally necessary to use excesses of from 2.02 to 2.85 equivalents, preferably from 2.10 to 2.45 equivalents, of the chloro compound of the formula (III) per mol of boron compound BW′W″W′″.

The purities of the products from the process of the invention are generally very high, but a further purification step, for example by recrystallization with addition of small amounts of activated carbon, may be necessary for specific applications (pharmaceutical intermediates). The yields of boronic acids are from 90 to 99%, while the yields of boronic acids are usually from 85 to 95%.

The raw materials for the synthesis of the invention (chloroaromatic and boron compound) are generally commercially available at a very favorable price, so that, in combination with the process engineering advantages mentioned and the associated high space-time yields and very high product purities, an extremely economical and very widely applicable process for preparing boronic and borinic acids has been found.

The process of the invention is illustrated by the following examples without the invention being restricted thereto:

### EXAMPLE 1

Preparation of Phenylboronic Acid

112.5 g of chlorbenzene (1 mol) are added dropwise to a suspension of 13.8 g of lithium granules (2.0 mol) in 350 ml of THF at −40° C. over a period of 2 hours. When the conversion determined by GC (the dark color of the reaction mixture does not allow the amount of Li consumed to be observed) is >98% (total of 4.5 hours), 145.8 g of triethyl borate (1.0 mol) are added at the same temperature over a period 30 minutes. After stirring for another one hour, 228 ml of 2.5% strength HCI are added. After THF and the ethanol formed from the boron compound have been distilled off under slightly reduced pressure and a maximum temperature of 60° C., the boronic acid formed precipitates and can, after cooling to 10° C. and setting a pH of 4.2, be filtered off and dried at max. 60° C. /100 mbar. This gives 118.2 g of phenylboronic acid (0.97 mol, 97%) as a colorless to yellowish powder, HPLC purity >99%.

### EXAMPLE 2

Preparation of p-tolylboronic Acid

A solution of 253 g of p-chlorotoluene (2.0 mol) and 207.6 g of trimethyl borate (2.0 mol) in 250 ml of THF is added dropwise over a period of 2.5 hours to a suspension of 28 g of lithium granules (4.06 mol) in 350 ml of THF at −50° C. After stirring the mixture for another four hours at −50° C., HPLC indicated quantitative consumption of the chloroaromatic. After 400 ml 5% strength HCI had been added and THF and methanol had been distilled off, the boronic acid formed precipitated and was, after cooling to 10° C., isolated by filtration. Drying at max. 65° C. /110 mbar gave 264.8 g of p-tolylboronic acid (1.95 ml, 97.5%) as a colorless to slightly yellowish solid.

### EXAMPLE 3

Preparation of di-p-tolylborinic Acid

A solution of 253 g of p-chlortoluene (2.0 mol) and 104 g of trimethyl borate (1.0 mol) in 150 ml of diisopropyl ether is added dropwise over a period of 2.5 hours to a suspension of 28 g of lithium granules (4.06 mol) in 350 ml of diisopropyl ether at −20° C. After stirring the mixture for another four hours at −20° C., HPLC indicated quantitative consumption of the chloroaromatic. After 340 ml of 2.5% HCI had been added and diisopropyl ether and methanol had been distilled off, the borinic acid formed precipitated and was, after cooling to 10° C., isolated by filtration. Drying at 70° C. /110 mbar gave di-p-tolylborinic acid as a yellowish solid in a yield of 88%, HPLC purity >95%.

### EXAMPLE 4

Preparation of p-anisylboronic Acid

The procedure of Example 1 was repeated using p-chloranisol to give p-anisylboronic acid in a yield of 96% and an HPLC purity of >98.5%.

### EXAMPLE 5

Preparation of m-fluorophenylboronic Acid

The procedure of Example 1 was repeated using m -fluorochlorobenzene to give m-fluorophenylboronic acid in a yield of 95%.

### EXAMPLE 6

Preparation of furan-2-boronic Acid

The procedure of Example 1 was repeated using 2-chlorofuran to give 2-furanboronic acid as a dark oil in a crude yield of 87%. After filtration through Primisil (solvent: 1:1 a mixture of methanol/dichloromethane) and evaporation, the product was obtained in an HPLC purity of 97%.

### EXAMPLE 7

Preparation of p-trifluoromethylphenylboronic Acid

The procedure of Example 1 was repeated, but at a reaction temperature of −65° C. and using trimethyl borate, to give p -trifluoromethylphenylboronic acid in a yield of 94% (HPLC a/a 98.1%). Drying at 70° C. and 5 mbar gave the anhydride of this boronic acid.

1. A process for preparing boronic acids of the formula (I) and borinic acids of the formula (II), 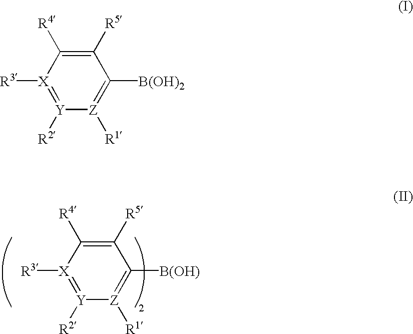
where
the substituents R^{1′} to R^{5′} are each, independently of one another, H, CH₃, straight-chain or branched C₁-C₈-alkyl, F, CₙH_{2n+1-f}F_{f} where n=1 to 8 carbon atoms and f=1 to 2n+1 fluorine atoms, CH(OC₁-C₅-alkyl)₂, C(C₁-C₅-alkyl), (OC1-C₅-alkyl), CH₂(OC₁-C₅-alkyl), CH(CH₃)(OC₁-C₅-alkyl), C₁-C₅-alkoxy, N(C₁-C₅-alkyl)₂, phenyl, substituted phenyl, aryl, heteroaryl, S(C₁-C₅-alkyl), Pphenyl₂, Paryl₂ or P(C₁-C₅-alkyl)₂ and
the symbols X, Y and Z are each, independently of one another, carbon or XR^{3′}, YR^{2′} and/or ZR^{1′} are/is nitrogen or XR^{3′} and YR ²′ are together oxygen or XR^{3′} and YR^{2′} are together N(C₁-C₅-alkyl) or N(SiMe₃) or XR^{3′} and YR^{2′} are together sulfur,
by reaction of chloroaromatics of the formula (III) with lithium metal and boron compounds BW′W″W′″, where W′, W″ and W′″ are each, independently of one another, C₁-C₆-alkoxy, fluorine, chlorine, bromine, iodine, N(C₁-C₆-alkyl)₂ or S(C₁-C₅-alkyl), in a solvent at temperatures in the range from −100 to 80° C.

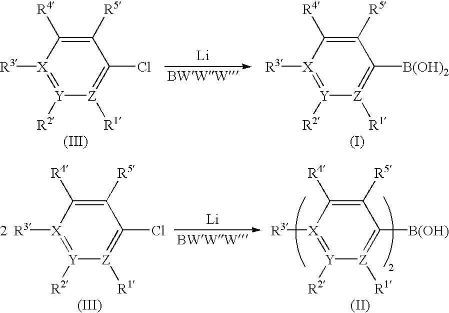

2. The process as claimed in claim 1, wherein the lithium is used in the form of dispersions, powder, turnings or sand.

3. The process as claimed in claim 1, wherein the solvent is selected from the following group: triethylamine, diethyl ether, tetrahydrofuran, di-n-butyl ether, tert.-butyl methyl ether, xylene, toluene, toluene/tetrahydrofuran mixtures, anisole and diisopropyl ether, and solvent mixtures comprising one of the above solvents.

4. The process as claimed in claim 1, wherein boronic acids of the formula (I) are prepared using from 0.96 to 1.30 equivalents of the chloro compound (III) per mol of boron compound BW′W″W′″.

5. The process as claimed in claim 1, wherein borinic acids of the formula (II) are prepared using from 2.02 to 2.85 equivalents of the chloro compound (III) per mol of boron compound BW′W″W′″.

6. The process as claimed in claim 1, wherein the boron compound of the formula BW′W″W′″ is a trialkoxyborane, BF₃*OR₂ (where R=CH₃, C₂H₅, C₃H₇, C₄H₉), BF₃*THF, BCl₃ or BBr₃, Cl₂B(OR) or BrB(NMe₂)₂, where R is as defined above.

7. The process as claimed in claim 1, wherein the reaction of the chloroaromatic with the lithium metal to form a lithioaromatic and the reaction of the lithioaromatic with the boron compound BW′W″W′″ are carried out in one reaction vessel at the same or essentially the same temperature.

8. The process as claimed in claim 1, wherein the chloroaromatic is reacted simultaneously with lithium and the boron compound BW′W″W′″ while stirring.

9. The process as claimed in claim 1, wherein the preparation of a lithioaromatic and the reaction with a boron compound take place in two separate reaction vessels and the two reactions are carried out at the same temperature or an only slightly different temperature (<50 K difference).

10. The process as claimed in claim 1, wherein the reaction solution obtained is subsequently hydrolyzed and worked up by appropriate methods.
